(19) United States
(12) Patent Application Publication
(10) Pub. No.: US 2022/0156709 A1
(43) Pub. Date: May 19, 2022

(54) ONLINE PAYMENT SYSTEM

(71) Applicant: SEMAFONE LIMITED, Guildford, Surrey (GB)

(72) Inventors: Thomas BALDWIN, Guildford (GB); Ben RAFFERTY, Guildford (GB); Graham PREEDY, Guildford (GB)

(73) Assignee: SEMAFONE LIMITED, Guildford, Surrey (GB)

(21) Appl. No.: 17/607,588

(22) PCT Filed: Apr. 30, 2020
(86) PCT No.: PCT/GB2020/051058

§ 371 Date: Oct. 29, 2021

(30) Foreign Application Priority Data
Apr. 30, 2019 (GB) 1906083.9

(51) Int. Cl. G06Q 20/12; G06Q 20/38; G06Q 20/40; G06Q 30/06

(52) U.S. Cl. CPC G06Q 20/12; G06Q 30/0613; G06Q 20/401; G06Q 20/386

(57) ABSTRACT

A system and method for facilitating an online transaction between a customer and a merchant, wherein receipt of an input from a merchant server defining a specified payment transaction causes a link generation module to generate a URL link uniquely associated with an online data capture resource for the specified transaction, such that activation of said link by a customer device facilitates a data capture process causing payment data to be provided to a payment module for completion of said specified financial transaction via a payment service provider.

This invention relates generally to an online payment system and, more particularly, to a computer-implemented apparatus and method for facilitating secure online financial transactions arising from real-time communications, such as web chats, conducted over a network between a merchant and a customer. In recent years, it has become increasingly common for customers and potential customers to reach out directly to merchants, for example, via telephone or web chats (both human and virtual or Artificial Intelligence agents), preferring the personal service and immediate response to queries these can provide, compared with an automated online ordering system. As such, it is commonplace for a user to agree to purchase goods or services via live communications media and, clearly, it is highly desirable for a seamless and secure financial transaction to be supported within the channel of engagement, e.g. directly from a web chat or telephone call, without having to terminate or suspend the communication session whilst the transaction is undertaken or, worse, moving channels for example from e-commerce webchat to contact centre voice. Equally, however, it is highly desirable to provide means for completing such a financial transaction without the need to divulge, over the network to the customer service representative hosting the chat session, credit card and/or other personal information required to complete the transaction.

US Patent Application No. 2015/0269575 describes a system for enabling secure payment transactions over a network, so as to complete a purchase agreed during a web chat, wherein the customer is provided (via the web chat facility) a unique URL payment link and, when the customer opens the link, they are connected over the network to an order processing system facilitated by the merchant, but separate from the chat application program. Once the user has input all of the required sensitive (and non-sensitive) payment information to the order processing system, and they have selected to submit such payment information, it is encrypted and displayed on the screen of the customer service representative and, at that point, the customer service representative can complete the purchase by causing the sensitive payment information, together with any non-sensitive payment information gathered during the web chat and/or entered by the user via the order processing system, to be submitted to a third party business entity so as to effect payment.

However, there are some drawbacks and issues associated with this arrangement. Firstly, unless and until the customer has finished entering the sensitive payment information and selected to submit it, the customer service representative has no way of knowing how the transaction process is progressing at all; they are not appraised of any such progress until all of the sensitive payment information has been input and the customer has clicked ‘submit on the order processing system payment screen. Furthermore, and considering the fact that non-sensitive payment information is entered by the customer service representative separately from the customer entry of the sensitive payment information, there is no facility whereby the customer can check and amend the non-sensitive payment information on the order processing system payment screen. Even more critically, the payment process necessarily passes through the merchant's own processing system before being passed to a third party business entity for completion. In other words, there is a direct connection, over the network, between the chat application program and the third party business entity.

This means that the merchant's own chat application program receives and stores (temporarily or otherwise) customer payment information and, even though it is displayed in masked form to the customer service representative, it is, at some stage, present in the merchant's own system in unencyrypted form. This means that the merchant's support help desk center would be considered a security risk within the scope of the PCI Security Council data security standards, placing a high (and expensive) burden on the merchant's business to mitigate the risk. For this reason, it is highly desirable to place as many of such security risks as possible outside of the scope of the business, or ideally not handle the data at all.

UK Patent Application No. Gb2553857 describes a secure order transfer system that can be used to complete a payment for an order made by, for example, a telephone call, wherein, first, a unique transfer code is generated and sent to the person to be billed (via, say, SMS message). The person to be billed must then return that unique transfer code for verification before the person to be billed is forwarded to a payment platform to complete the transaction. Because the customer completes the financial transaction directly with the payment service provider, the order generator must await a notification from the payment service provider that the payment process has been completed before they can complete the order. Thus, whilst the channel of engagement (e.g. telephone call) can be maintained whilst the payment process is in progress, the order generator has no means of knowing how, or even if, the payment process is proceeding.

Aspects of the present invention seek to address at least some of these issues and, in accordance with a first aspect of the invention, there is provided a computer-implemented method of facilitating a specified financial transaction between a customer and a merchant, comprising the steps of:
configuring a hosting platform for communication with a customer device and including a merchant interface module for communication with a merchant server, the hosting platform comprising a link generation module, a data capture module, a payment module and a link status and user activity module;
the method comprising:
upon receipt of an input from the merchant server defining the said specified financial transaction, causing the link generation module to generate a URL link uniquely associated with an online data capture resource for the specified financial transaction;
upon activation of said link by a said customer device, facilitating a data capture process comprising receiving inputs therefrom comprising customer payment data;
recording one or more activity data representative of respective one or more specified events within said data capture process;
providing, to said merchant notification application program interface during said data capture process, data representative of said one or more specified events;

and
upon completion of said data capture process, causing said payment data to be provided to said payment module for completion of said specified financial transaction via a payment service provider.

In a preferred exemplary embodiment, the said data capture process may be facilitated at said hosting platform. Optionally, the link generation module may generate a link in the form of a domain and a unique reference identification number, and a computationally different Link Reference ID. The specified events may comprise a link status and/or user activity in respect of said link and/or said online data capture resource.

In an exemplary embodiment, the URL link may have a timestamp associated therewith, and the method may include the step of: upon activation of said link by a customer device, determining, using said timestamp, a period of time since the link was generated and, if the determined period of time exceeds a predetermined time period, blocking customer access to said online data capture resource.

In an embodiment, the link status and user activity module may include a telemetry module configured to obtain, in substantially real time, data input to said online data capture resource and generate link status and/or user activity data representative of specified events; and, optionally, the telemetry module may be configured to match data input to said online data capture resource to predetermined input data formats for predefined events to determine link status and/or user activity data. In such embodiments, the specified events may comprise one or more of entering a passcode, entering a Bank Identification Number (BIN), entering a start and/or expiry date of a payment card. The telemetry module may be configured to generate encrypted link status and/or user activity data and may cause said encrypted link status and/or user activity data to be transmitted to said merchant notification application program interface for display.

In an embodiment, the said recording activity data may comprise recording each activation instance in respect of said link; and optionally, the method may comprise the step of, upon activation of said link by a customer device, determining a number of activation instances recorded in respect of said link and, in the event that a current activation instance causes the total number of activation instances to exceed a predetermined number, blocking customer access to said online capture resource.

A method according to an exemplary embodiment may comprise monitoring said data capture process to determine if the input customer payment data meets predefined characteristics and, if not, terminating the data capture process; and, optionally, in this case, said recording activity data may comprise recording each instance of termination of said data capture process. Optionally, the method may further comprise, in respect of a predetermined number of instances of termination of the data capture process, clearing the online data capture resource and permitting the customer a further attempt, in the event that the number of instances of termination of the data capture process exceeds said predetermined number, blocking further customer access to the online data capture resource.

In an exemplary embodiment of the invention, the above-mentioned blocking of customer access to the online data capture resource may be recorded as activity data for provision to the merchant notification application program interface.

A method according to an embodiment of the invention may comprise, upon receipt of a respective command from a merchant server, deactivating a link.

In an exemplary embodiment, the method may comprise recording a location of a customer device prior to generating a link, and, upon activation of the link by a said customer device, determining its location and allowing access to the online data capture resource only if its said location is within a predetermined geographical area relative to said recorded location.

In accordance with another aspect of the invention, there is provided a system comprising an online payment facilitation platform for facilitating a specified financial transaction between a customer and a merchant, the platform being configured for communication with a customer device and a merchant server, and including a merchant interface module for communication with a said merchant server, a link generation module, a data capture module, a payment module and a link status and user activity module, wherein said data capture module is communicably isolated from the merchant interface module by an access control module; and wherein:
the link generation module is configured, upon receipt of an input from the merchant server defining the said specified financial transaction, to generate a URL link uniquely associated with an online data capture resource for the specified financial transaction and return the link to the merchant server for supply, via an external communication link, to a specified customer;
the data capture module is configured to, upon activation of the said link by a customer device, receive inputs from a data capture process performed from a customer device via the respective online data capture resource, said inputs comprising customer payment data;
the access control module being configured to receive, from the data capture module during said data capture process, event data representative of progress and/or outcomes of said data capture process, and record said event data in said link activity module;
the merchant interface module being configured to receive, from said link status and user activity module during said data capture process, said event data and output information representative thereof to a merchant server so as to provide to the merchant substantially real-time updates of the progress of the data capture process; and
the payment module being configured to receive said customer payment data and cause said specified financial transaction to be performed via a payment service provider.

Optionally, the payment module may be configured to record payment event data during the performance of said financial transaction and the merchant interface is configured to receive, prom said payment module during performance of said financial transaction, said payment event data and output information representative thereof to a merchant server so as to provide to the merchant substantially real-time updates of the progress of the financial transaction.

In an embodiment, the platform may further comprise a Bank Identification Number (BIN) list service module configured to, upon activation of said link by a customer device and prior to the data capture process, receive data representative of a payment type to be used by the customer to complete the financial transaction, determine whether or not said payment type is an allowable payment type, and permit the data capture process to proceed only if said payment type is determined to be an allowable payment type. Optionally, the BIN list service may be configured to compute respective surcharge payments in respect of specified payment types. The BIN list service may include data representative of characteristics of each of a plurality of BINs or BIN ranges associated with respective allowable payment types, receive data in a BIN field of the online data capture resource, and permit data capture to proceed only if the data entered in said BIN field corresponds to a BIN of an allowable payment type.

In an exemplary embodiment, the link may comprise a domain and a link reference ID in the form of a randomly generated VLN. Optionally, the event data may be recorded as a result of a status change of said link, identifiable by the provision of a newly-obtained random number associated with said link.

These and other aspects of the invention will become apparent from the following specific description, in which embodiments of the present invention will be described in detail, by way of examples only, and with reference to the following drawings in which:

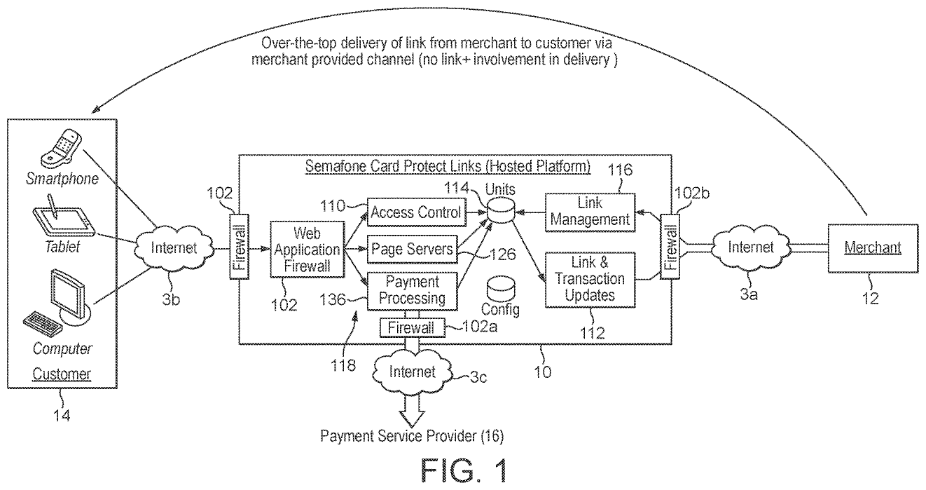

FIG. 1 is a schematic diagram illustrating a computer-implemented apparatus according to an exemplary embodiment of the invention;

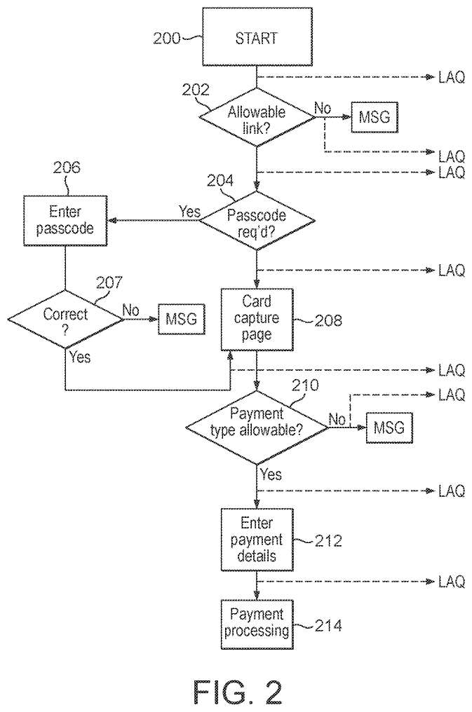

FIG. 2 is a schematic diagram illustrating a successful on-line payment method according to an exemplary embodiment of the present invention;

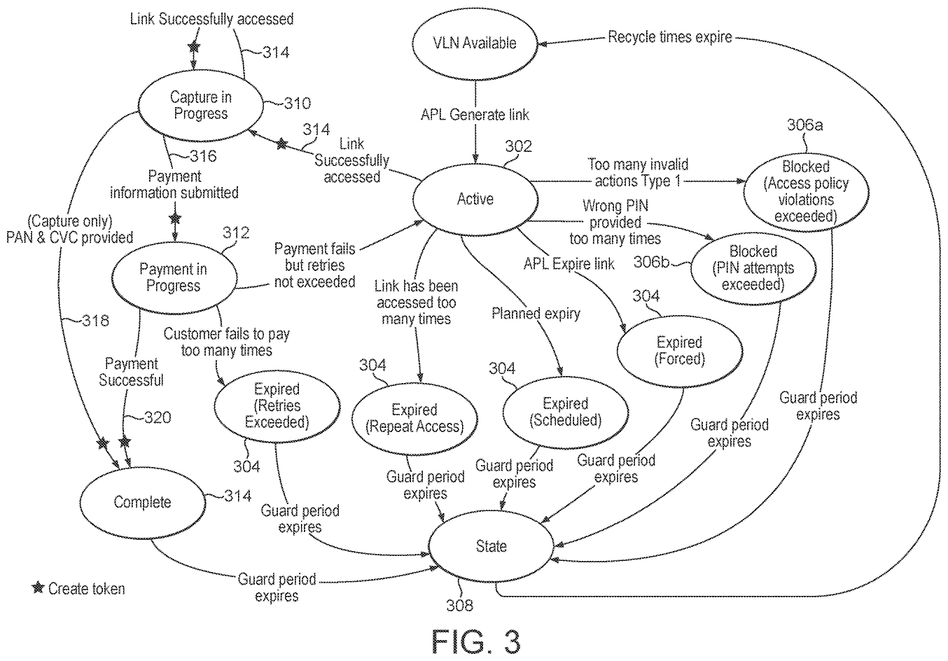

FIG. 3 is a schematic diagram illustrating a lifecycle of a link generated using apparatus according to an exemplary embodiment of the invention, showing link states but not link activity;

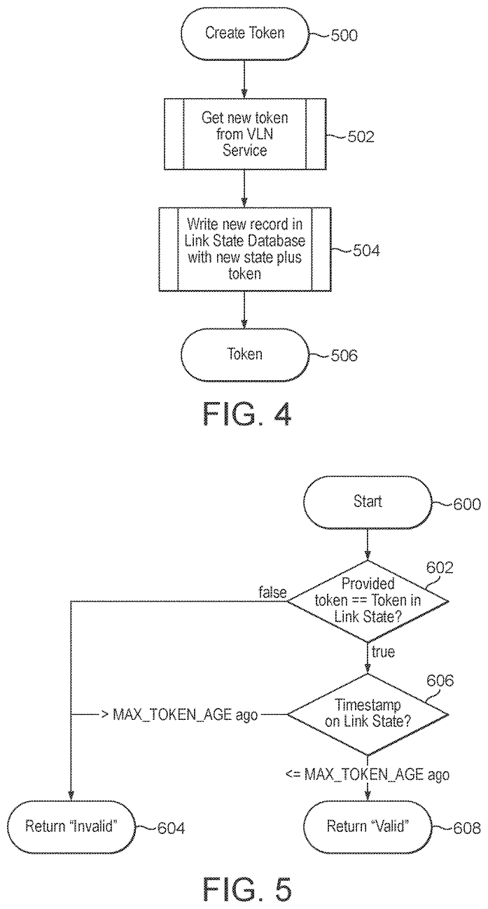

FIG. 4 is a schematic flow diagram illustrating a Token creation process for use in an exemplary embodiment of the invention; and

FIG. 5 is a schematic flow diagram illustrating a Token validation process for use in an exemplary embodiment of the present invention.

Thus, the present invention seeks to provide a mechanism for secure capture and transaction processing of sensitive (e.g. credit card) payment data, especially suitable for non-voice communication channels (e.g. e-commerce, webchat, etc), but equally suitable for situations in which the customer engagement is by voice call and, in any event, where it is important to stay within the channel of customer engagement, to remove cardholder data from the merchant, merchant agent, and merchant engagement channel, whilst providing a frictionless customer experience and keep the merchant agent updated throughout the process.

The computer-implemented apparatus of the present invention is, in the following exemplary embodiment of the invention, implemented in software, which may be running on definable computing devices and/or via cloud-based services. However, it will be appreciated that some or all of the functionality provided by the apparatus may be provided using hardware.

Referring to FIG. 1 of the drawings, computer-implemented apparatus according to an exemplary embodiment of the invention comprises a hosted platform 10, which is intended to be communicably couplable (via respective firewalls 102, 102a), over a network 3a, to one or more merchant platforms 12 and over a network 3b to one or more customer platforms 14. The customer platforms 14 may comprise, for example, smartphones, tablets, personal computers, laptops, or any personal computing device which has access to the internet via a browser interface etc. The hosted platform 10 is also configured to be communicate, via the firewall 102a and over a network 3c, with any third-party payment service providers 16.

The hosted platform 10 is configured to be utilised by multiple merchants, each of which needs to first register with the hosted platform to generate a respective merchant account. It is these merchant accounts that can be used to generate secure payment links when required.

In a transaction process, a merchant platform 12 includes a web chat program application module, which supports and facilitates webchat functionality, over the network 3b, with a customer platform 14. When a customer clicks into their web browser to instigate a webchat with the merchant platform 12 (in a known manner, as will be apparent to a person skilled in the art), a webchat window opens on the customer screen and a corresponding chat window opens on the screen of a merchant customer service representative's computing device. The webchat is conducted over the network 3b, between the customer and the customer service representative, over a first communication channel and the entire ‘conversation’ between them is recorded on both of their screens as communications are passed back and forth between them. Ultimately, the customer may wish to make a purchase and indicates this to the customer service representative (via the webchat program application module) over the first communication channel.

Once a financial transaction has been agreed in this manner, the customer service representative (at the merchant platform) transmits a link request to the hosted platform 10 over a second communication channel. The link request will include non-sensitive customer data (customer reference number) the value of the transaction, and any other information that is necessary to complete the transaction e.g. the customers address. The merchant is registered with the hosted platform 10 so, with the merchant ID data and the financial transaction data transmitted from the customer service representative, a unique secure payment link can be generated. In an exemplary embodiment of the invention, the link (which may take the visual form of a conventional URL or QR code, for example) comprises a domain of the Link creation and data collection platform ingress point 102, together with a unique, randomly-generated reference number (unique to this particular transaction) in the form of a very long number (VLN). It will be understood by a person skilled in the art that the link, thus generated, is a URL to a secure payment webpage hosted by the platform 10 and dedicated to the current customer, merchant and financial transaction, as identified via the link request, and not, in contrast to the prior art, a URL directly to the payment service provider payment pages.

The hosted platform transmits the link to the customer service representative (at the merchant) over the internet 3b, and the customer service representative conveys the link to the customer. This may be done (safely) by displaying the link within the webchat window alongside the rest of the ‘conversation’ shown in the over-the-top-delivery in FIG. 1, or it may be sent (over a third communication channel (not shown) to the user's mobile phone as a text message (with any associated message to the customer), within an email to the user's email address for immediate payment, or created as a link to for the customer to visit within a merchants web-portal or even as a QR code on a piece of mail for a payment to be made at a later date. The present invention has the unique advantage that, even in these latter scenarios, where a customer visits these links at a later date, important notifications can be generated by the hosted platform 10 to indicate that the link has been opened and that a customer is attempting to make a payment, because the link opens a secure payment webpage hosted by the platform 10, rather than linking through to the Payment Service Provider 16 as in prior art arrangements, and as described in more detail below.

Each link, thus generated, represents a single transaction that the merchant wishes the third party payment service to conduct on its behalf and contains all of the associated data necessary to perform the transaction (e.g. the value of the transaction and (at least) a customer ID or reference number, as well as security and card acceptance policy restrictions. Importantly each link can be delivered across multiple channels and when supplied with additional meta-data can provide a merchant with important analytical data informing them about which channels are most effective to trigger payments from customers.

Irrespective of the manner of transmittal of the link to the customer, when it is opened, the customer device 14 is linked through to a capture page, generated by the page servers 126 of the hosted platform 10 and displayed to the user on their own platform. This capture page enables the customer to enter their sensitive payment details to the hosted platform 10, and entirely separately from the merchant platform 12, whilst enabling the hosted platform to monitor progress of the payment process and provide real-time interim updates as the payment process is progressing, as well providing the ultimate notification of completion (or failure) of the payment process to the merchant platform 14. Thus, if the customer is completing the financial transaction on the same computing device as that used to conduct the associated web chat, then the web chat window hosted by the merchant 12 can remain live whilst the financial transaction is being completed via the hosted platform 10. The customer can enter their sensitive payment data, via the capture page, and the financial transaction is completed, via the payment processing module 136 hosted by the platform 10, completely separately from the customer service representative at the merchant platform 14, thus placing the security risk outside of the scope of the merchant business.

In further contrast to the prior art, the hosted platform 10 remains communicably coupled, via the second communication channel 3b, to the merchant server 14 as well as, via a third, separate communication channel 3c to the payment service provider 16. Thus, whilst the financial transaction is taking place over the fourth communication channel between the customer and the hosted platform 10 (and, ultimately, the payment service provider 16), the hosted platform 10 can provide real-time updates as to progress of the financial transaction to the customer service representative at the merchant server, without divulging any sensitive details of the transaction. Such updates typically comprise current link status and/or link activity (Purely by way of example, link activity may comprise user interaction with the link from simply opening the link, or entering a Bank Identification Number (BIN) into the correct field on the data capture page, whereas, a link state might be ‘expired’ if the link has expired either due to some predetermined time period elapsing, exceeding the number of attempts opening the link, or as a result of successful payment processing).

Thus, it may first display a message when the link is accessed to indicate that a financial transaction is in progress. Next, it may provide an indication that the card number has been entered, and then when the expiry date has been entered
these may simply appear in real time on the customer services representative's screen as notifications that data is entered by the customer into the screen representing the payment gateway, and take the form of periodic updates, e.g. ‘payment information entered and validated’, ‘payment processing’ and ‘payment complete’; or, indeed, ‘payment failed’, ‘link expired’, etc, as will be described in more detail later. The hosted platform may, eventually, cause a message to be displayed at the customer service representative's screen indicating that all necessary payment data has been successfully entered and submitted and, finally, that the payment has been processed and the financial transaction is complete. Separately, any financial or reconciliation information is encrypted and sent separately to a merchant's central business system, but importantly not to the agent—who simply needs to know that the process has been completed, satisfactorily or otherwise. All of these messages, which represent link ‘state’ changes and/or link activity, as will be described in more detail hereinafter, could appear in real time within the chat window in which the original conversation is/was held, although this is by no means essential. What is critical here is that the hosted platform enables a unique payment to be completed and supported by opening a link, wherein the link is generated using merchant/customer non-sensitive data and a randomly-generated VLN, and the input of sensitive payment data is performed directly from the customer to the Link creation and data collection platform, thus placing the security risk outside of the scope of the merchant business whilst still allowing the merchant to receive real-time updates as to the progress of the financial transaction and enabling the financial transaction process to take place without the need to terminate or suspend the web chat facility between the customer and the customer services representative who negotiated the financial transaction.

The hosted platform 10 can be used in two different modes, namely the ‘Collect Mode’ and the ‘Transact Mode’. In the Collect mode, the hosted platform collects the cardholder details, and makes them available for secure collection by an in-scope merchant system. In this case, the hosted platform does not complete a transact with the captured information against a third-party Payment Service Provider. In the Transact Mode, the hosted platform captures cardholder details and combines them with other merchant information into the transaction, which the hosted platform performs against the Payment Service Provider, using the merchant's account credentials with that Payment Service Provider.

A computer-implemented apparatus according to an exemplary embodiment of the present invention comprises the above-mentioned hosted platform 10 that is configured to operate between a merchant CRM system 12, including (optionally) an in-scope merchant system, a customer computing device (e.g. personal computer) 14 and a (optional) Payment Service Provider 16 (via a payment module, not shown). The hosted platform 10 comprises a plurality of modules, which may be implemented in software to provide the required functionality, although it will be appreciated that some or all of the modules could be implemented, partly or wholly, in hardware in the form of electronic circuits, and the present invention is not necessarily intended to be limited in this regard. Furthermore, the modules may all be configured and interconnected locally, or they may be, partly or wholly, implemented in a distributed form, with connectivity provided over a network, in a cloud based system, for example. In the following description, the hosted platform 10 is described as a single computer program in “black box” form with local connectivity between the functional software ‘modules’ but it is to be understood that the present invention is not necessarily intended to be limited in this regard.

For completeness, the hosted platform 10 further comprises:
A Web Application Firewall (WAF) which filters unwanted traffic.
A Payment Processing Module 136
An Access Control Module 110 implements the fine detail of the business rules around access control, using data held in an Access Control Record and a Link State Record (via a Link Activity Service). It may also use the services of an external geo-IP system, which is a known technology that restricts access to Internet content based upon the user's geographical location).
A Link Activity Module 112 is responsible for receiving updates about the progress of a link from a number of sources, propagating this information and storing appropriate parts of it. It also supports explicit queries of the state of a link and so supports both push and pull requests
A Merchant Link Management 116 and a Merchant Link Notification API provide a number of services responsible for interacting with the merchant. They define the interface and provide decoupling between the API and the underlying services and databases.
Databases: A Link state Database documents the characteristics (plus history and state of) each link; and a Merchant Configuration Database contains information about each merchant's payment system, which is common across all of the links used by a given merchant.

Before a merchant can use the hosted platform 10, one or more Merchant Payment Configurations must be created for them, and these are stored in a location accessible to a Link Management Service implemented in the Merchant Link Management API 116. A Merchant Payment Configuration defines payment-specific configuration defined by various merchant data and credentials.

In an exemplary embodiment merchant registration may be performed manually, although it is envisaged that an automated interface to the data required for merchant registration may alternatively be provided.

When a financial transaction has been agreed upon between a customer and a merchant in a manner as described above, the merchant invokes a Generate Link method of the Link Management service 120, receiving in return:
The link itself (used only by the customer to access the link)
A Link Reference ID, which all merchant-side systems use in communicating with hosted platform about the progress and outcome of the link
The passcode for the link (if one will be required) The request will include the security requirements for accessing the link such as customer device IP, and includes the link lifetime. It will also specify whether the captured data is to be held for collection by the merchant or passed on their behalf to a Payment Services Provider 16 for processing.

The hosted platform need provide no mechanism to communicate a link (and passcode, where used) to the customer. This data can be provided to the merchant, who carries the responsibility for delivering it to the customer. The merchant may use any sufficiently secure channel of their choosing to achieve this, as described above. Where a passcode is to be used, the merchant can communicate this to the customer via a different communications channel to the link URL to preserve its value as a second security factor.

In most cases, it is envisaged that the merchant will provide the link to the customer in a form where they can simply click on the link (e.g. in an email), causing it to open in their default browser. In an e-commerce scenario, the merchant may embed the capture page resulting from the link in an iframe inside their e-commerce system and the link request can designate whether this resulting link will be provisioned as an iFrame or standalone paypage. Alternatively, they may redirect the user to the capture page—in this case, the result page will be provided by the merchant (not by the hosted platform), and the merchant will be responsible for consuming progress updates from the hosted platform and communicating these to the merchant agent or business system.

It is envisaged that links will only be accessible via a suitable security protocol.

Access to the link is conditional on the customer meeting the access control requirements specified by the merchant at the time the link was created. In addition, the Web Application Firewall, which provides the public facing front of the hosted platform, can implement its own protections (e.g. globally disallowing access to user agent strings known to represent attack tools). These protections can be frequently reviewed and adapted in the light of emerging threats. They would take priority over the merchant acceptance rules in blocking suspicious access attempts.

In the event the link is not accessible (e.g. because it has expired) a message is displayed.

When the customer attempts to open the link, the Web Application Firewall checks with an Access Control Service in the Access Control module 110 whether basic access control requirements (e.g. IP address match) are met, and if so whether a passcode is required. If it is, the WAF causes a static passcode capture page to be displayed, to enable the user to enter their passcode (provided by other communication means by the merchant to the customer). If no passcode is required, the WAF allows the request to continue.

The user who must provide a passcode submits the passcode via the passcode capture page, which causes the request to be passed back towards the WAF. Again, the WAF checks with the Access Control Service—this time, the passcode is validated and the WAF allows the request to continue.

A Page Server module 126 retrieves details of the transaction associated with this link from the Link Activity module 112, and uses the information to vend a capture page to the user. It is significant that activation of the link does not serve the payment service provider pages, i.e. does not link the customer directly through to the PSP 16 but, instead, causes the above-mentioned capture page to be generated to enable the customer to enter their sensitive payment details to the hosted platform 10, entirely separately from the merchant platform, whilst facilitating the payment process with the payment service provider 16. This aspect enables the real-time updates as to progress of the payment process to be detected and notified, whilst keeping the payment process itself outside of the scope of the merchant's business. The capture page will contain some (non-sensitive) information about the transaction—e.g. merchant logo, merchant name, overview of the transaction purpose and the amount (where and as appropriate). The page also includes a time limited access control token which limits access to all subsequent pages. If the customer does not submit the payment before this token expires, they will have to restart the process (including providing a passcode where one is needed) and may require that the merchant create a new link.

The current capture page includes telemetry whereby updates on the user actions (e.g. “BIN entered, assessed as Amex (not accepted by merchant)”) are transmitted to a Link Activity Queue in the Link Activity module 126 for consumption by interested merchant systems. Access to the telemetry service is controlled by the token referenced above. The telemetry function may extend to recording, in real-time, customer data entry and causing a corresponding status update to be displayed on the merchant's screen.

User-entered data is validated using a BIN List Service, and with an in-page ID validation function, to reduce the risk of well-intentioned users submitting unacceptable data. The BIN List Service (not shown) is used to help validate PAN and CVC lengths, to confirm acceptability of the card (according to the merchant's commercial rules) or handle and apply surcharging rules. Access to the BIN List Service is controlled by the token referenced above.

All of the user entered data is encrypted in-browser using a public key provided in the vended page. This additional layer of encryption minimises the number of hosted platform components which are exposed to card data in the clear. When the user submits the card data for processing, again the WAF queries the Access Control module 110 for acceptability of the request (including the presence of a valid token) and routes the submission to a Payment Services module (not shown). The Payment Services module then decrypts the captured data, performs some basic validation on this data and then routes it to either the Payment Processing module 136 (if Transact Mode is selected) or a Card Data Store in the Merchant Notification API (if Collect Mode is selected for this link). In this latter case, the Payment Services module re-encrypts the captured data with the merchants' Public Key before pushing it to the Card Data Store.

A results page server (not shown) polls a Payment Progress Service, which is consuming updates from a Link Activity Queue (LAQ) in the Merchant Notification API. As the transaction progresses, updates are thus returned to the customer.

The Payment Processing Service (not shown) retrieves the full details provided by the merchant which apply to this transaction (e.g. merchant transaction reference, any fraud service parameters) from a Link Database and combines these with the customer-provided card data to create a request towards a Payment Module (PM). The PM 16a processes this request, and causes the Link Activity Queue (LAQ) to be updated.

Throughout the entirety of this flow, the Access Control Service in the Access Control module 110 provides updates about the access attempts (successful and failed) towards a Link Activity Service, which places them on the Link Activity Queue for consumption by interested merchant systems.

Referring to FIG. 2 of the drawings, a payment process (where a passcode is required to access the link) is illustrated in terms of communications between the various elements of the hosted platform and the customer/PSP.

The process starts at step 200, wherein a link command is sent from the customer browser 14 to the hosted platform 10. If the link is allowable (at step 202), hosted platform 10 determines if a passcode is required for the link (at step 204). If not, the process proceeds to step 208. If so, the link command and token are transmitted to the Access Control Service and a Passcode Capture Page data is returned with the token, through the WAF, to the customer browser 14. The Passcode Capture Page is displayed on the user's device, allowing them to enter a passcode (at step 206) provided to them by the merchant through a selected secure means (e.g. email).

Next, at step 207, when the customer has entered the passcode at step 206, the link and passcode are returned to the hosted platform 10 to verify if the entered passcode is correct. If it is, a link command is sent to a Capture Page Server and Card Capture Page data is communicated back to the customer browser 14, via the WAF. The Card Capture Page is displayed on the user's device at step 208, and prompts them to indicate the type of card with which they want to make payment. The response is sent, at step 210, to a BIN List Service and a result returned, indicating if the payment type entered is allowable.

At step 212 (and assuming the BIN List query returned a positive result), the customer is prompted to enter the remainder of their payment details. When these have been entered and provided the payment details meet the parametric requirements of the selected BIN, a payment submission is transmitted for processing (at step 214) by the PSP 16. During this process, a Payment Service in the Payment Processing module 136 is periodically polled for payment progress updates, and results are returned to the customer browser to indicate that the payment process has started, and when payment has been completed (or not). It will be understood that the process is similar in substantially all respects when a passcode is not required.

The start of the process, the point at which the customer has successfully entered the passcode (if required) and moved to the Card Capture Page, the point at which the customer has successfully entered the card details and the payment request has been submitted, as well the points at which the Payment Module of the Hosted Platform 10 confirms that payment processing has started and also when it has been completed, all marks changes of link ‘state’. These ‘states’ are communicated to the customer browser and also available to the Link Activity Queue so that these updates can be communicated and displayed on the customer service representative's screen thereby providing real-time updates on payment progress (via link activity).

Indeed, each link generated by the host platform 10 has a defined lifecycle comprising a number of possible states, each of which can be made available, and communicated, to an interested merchant to provide real-time payment updates. These link states (but not link activity), and their descriptions, are illustrated in FIG. 3 of the drawings, and set out below:

VLN Available (300)—The VLN is not allocated to a specific link. It is available for use in fresh links.

No entries exist in the Link Database.

Active (302)—the VLN is allocated to a specific link and can be visited and used. A complete entry exists in the Link Database.

Expired (304)—The VLN is allocated to a specific link. The link can be visited, but not used (the user will see a “link unavailable” message. A partial entry exists in the Link Database (all PII is removed)

Blocked (306)—the VLN is allocated to a specific link. The link can be visited, but not used (the user will see a “link unavailable” message, either because some access policy violation has been exceeded 306a or the number of unsuccessful passcode entry times has been exceeded 306b). A partial entry exists in the Link Database (but all PII is removed)

Stale (308)—The VLN is not allocated to a specific link. It is not available for use in fresh links (yet). A partial entry exists in the Link Database (only Link State Records exist)

Capture in Progress (310) —The user has been granted access to the capture page

Payment In Progress (312)—The user has submitted card data in relation to this link. Used to prevent multiple simultaneous payment attempts

Complete (314)—The payment has completed successfully and the link should no longer be used

The above are just the link ‘states’, and the full (possible) set of link state/activity values that could, in various exemplary embodiments, be pulled from the Link Activity Queue, are set out later. It can be seen in FIG. 3 that a new token is created, and stored in association with the link, when a link is successfully accessed (314), payment information is submitted (316), PAN and CVC data is submitted (318), and when payment is successful (320). The generation of these tokens represents the respective link state changes. Other link state changes (‘active’, ‘expired’ and ‘blocked’ occur automatically and as a result of a predetermined event or expiry of a predetermined period.

A Link Database contains a number of records describing the merchant-generated links. Each record has two values which serve as a unique identifier. One is the VLN, taken from the link delivered to the customer. This is used by customer-facing systems. The other is the Link Reference ID, which is a long random number issued to the merchant, and used in all merchant-facing APIs. It cannot be used to access a payment link or access or control the payment process other than to force expire a link. This approach means only the merchant system which instructs the host platform to create a link need see the actual link itself; all other systems can use the “safe” Link Reference ID, disclosure of which does not endanger the link itself.

One Link State Record is created when the link is initially requested by the merchant, further Link State Records are created as the link is accessed and used. The Link State Record serves to store the current and previous states of a link. Each state transition results in a new record being written.

All of the link states are accessible to the merchant notification API, via the link activity queue, to enable real-time payment progress updates to be presented to the customer service representative.

An Access Control Record defines the restrictions that apply to any user attempting to access the payment link or any associated resources. It is created when the link is created and deleted when the link exits the Stale state. Since it contains IP addresses and thus PII, it is encrypted by the database engine.

The Access Control Service in the Access Control module 110 provides tokens to control access to resources needed once the capture page has loaded (e.g. BIN List Service, Browser Activity Service, results page updates). Tokens are generated on certain state transitions, as described above, and serve to ensure that the customer using a service is the same customer that accessed the capture page. These tokens expire after a configurable period of time.

Tokens may simply comprise a long random number created by the VLN Service for the Access Control Service on entry to a state and stored against the current state in the Link State Record. Tokens automatically expire when the link transitions to a new state, as the old token will not be associated with the new state (which will have a new token associated therewith). The Access Control Service also records state transitions when a request causes them.

The Access Control Service may use the services of a COTS Geo-IP service to provide the coordinates of the centre of the region where a customer IP address is believed to be located. It also provides the associated geoinformatics logic to allow the distance between two sets of coordinates to be computed. Using this functionality, the geographical location from which a link may be validly accessed can be restricted to a predetermined radius around the location of the IP address at which the customer caused the link to be requested.

Access requests are received for five types of interaction:
Capture page [causes state change into Capture In Progress]
Telemetry [no state change]
BIN List service [no state change]
Card Data submission [causes state change into Payment In Progress]
Card data transaction results [no state change]

Referring to FIG. 4 of the drawings, a token is created when a link is first generated and each time there is a change of state of the link. The process starts at step 500. At step 502, the token is created using the VLN Service 160. At step 504, a new record is written to the Link State Database 154 indicating the new state and the token. Then, at step 506, the token is added to the link (and the previous token is superseded and expires).

At each stage of a payment event, the validity of the token currently associated with the link is tested. Referring to FIG. 5 of the drawings, this process starts at step 600. At step 602, the token is compared with the most recent token stored in the Link State Record 154 for that link. If they do not match, an error is returned (at step 604). If they do match, at step 606, the time stamp on the token associated with the link is checked against the time stamp of the stored token. If a predetermined period of time has elapsed between the two, an error is returned (step 604). If that time period has not elapsed, a valid response is returned at step 608 indicating that the link and token are valid and the process can continue.

Each time a new token is required, the VLN Service 160 is required to return a random number of high-quality randomness. It will be appreciated from the above that it is used, not only to generate the link itself, but also for the link reference ID and the tokens. Both VLN and Link Reference ID share the characteristic that they must be globally unique and exist in an extremely sparse solution space, and remain computationally different such that one could be used to calculate the value of the other, in either direction. There exist a number of random number generation techniques that can be used to create VLNs of the required uniqueness and randomness, as will be known to a person skilled in the art.

The Link Activity Queue contains updates on the progress of a link, based on link state and also on link activity (i.e. user interaction with the link), any or all of which ‘updates’ can be pulled and sent to the Merchant Notification API for display. Each update contains a Link Reference ID, but it does not contain any sensitive data (including the link itself containing the VLN), such that it is always safe to display information from the Link Activity Queue directly to a merchant's customer service representative.

A list of possible events stored in the Link Activity Queue, is set out in a generalised form below, some of which events are indicated by broken lines in FIG. 2 of the drawings:

Access denied

Link requested, bad passcode provided

Link requested, passcode required

Link requested, correct passcode provided

Link accessed successfully (Passcode not required)

attempt N of M

Link accessed successfully (Passcode required)

attempt N of M

BIN check result: card scheme accepted, no

surcharge

Capture page loaded

Card data submitted

Card not accepted by merchant acceptance rules

(card scheme name)

Card passed merchant acceptance rules (card

scheme name)

CVC length check passed

Data entry length complete

Data entry ongoing

PAN check passed

User activity paused

User clicked submit

User entering cardholder name

User entering CVC

User entering expiry date

User entering PAN

Capture page served

Data available for collection

Card data decrypted

Card data submitted

Card data validated

Link transitioned to Active State

Link transitioned to Blocked State

Link transitioned to Capture In Progress State

Link transitioned to Complete

Link transitioned to Expired State

Link transitioned to Payment in Progress State

Link created

Payment failed

Payment submitted to Payment Module

Payment succeeded

Result received from Payment Module

It will be appreciated that any or all of these events/updates can be notified to the merchant's customer service representative (as a visual representation on their screen, for example). Furthermore, a PSP result queue receives final updates from the PSP 16 as to the progress of the financial transaction, Events can be pulled from either queue by the merchant using a dedicated client for the queuing technology chosen or by HTTPS long poll, for example, and as will be known to a person skilled in the art. In addition, or alternatively, events can be pushed to the merchant using, for example, a Push Notification Service, as will be known to a person skilled in the art. Thus, the Link Activity Queue and the PSP Result Queue can be used to provide a real-time progress report on the financial transaction process, whilst keeping the merchant's system out of scope.

It will be appreciated by a person skilled in the art, from the foregoing description, that modifications and variations can be made to the described embodiment without departing from the scope of the invention as defined in the appended claims.

1. A computer-implemented method of facilitating a specified financial transaction between a customer and a merchant, comprising the steps of:
configuring a hosting platform for communication with a customer device and including a merchant interface module for communication with a merchant server, the hosting platform comprising a link generation module, a data capture module, a payment module and a link status and user activity module;
the method comprising:
upon receipt of an input from the merchant server defining the said specified financial transaction, causing the link generation module to generate a URL link uniquely associated with an online data capture resource for the specified financial transaction;
upon activation of said link by a said customer device, facilitating a data capture process comprising receiving inputs therefrom comprising customer payment data;
recording one or more activity data representative of respective one or more specified events within said data capture process;
providing, to said merchant notification application program interface during said data capture process, data representative of said one or more specified events; and
upon completion of said data capture process, causing said payment data to be provided to said payment module for completion of said specified financial transaction via a payment service provider.

2.-24. (canceled)
